(19) United States
(12) Patent Application Publication
(10) Pub. No.: US 2005/0140071 A1
(43) Pub. Date: Jun. 30, 2005

(54) Table for use in cutting and including an automatically moving collection system

(75) Inventors: Peter W. Reist, Elmira (CA); Lester Martin, Elmira (CA)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: The Esab Group, Inc.

(21) Appl. No.: 10/843,057

(22) Filed: May 11, 2004

Related U.S. Application Data
(60) Provisional application No. 60/532,848, filed on Dec. 24, 2003.

(51) Int. Cl. B23K 7/00; B26D 7/06

(52) U.S. Cl. 266/48

(57) ABSTRACT

A table includes a pervious partition that is for supporting a workpiece while the workpiece is being cut in a manner that produces residue such as fumes and/or slag. A receptacle is positioned below the pervious partition for collecting at least some of the residue. The receptacle is mounted for back and forth movement relative to the pervious partition, so that the receptacle can be moved into optimal positions beneath the pervious partition for collecting residue which passes through the previous partition.

### CROSS REFERENCE TO RELATED APPLICATION

The present application claims the benefit of Provisional Patent Application No. 60/532,848, which was filed on Dec. 24, 2003, and is entirely incorporated herein by reference.

### BACKGROUND OF THE INVENTION

The present invention pertains to tables for supporting workpieces that are being cut and, more particularly, to such tables with moving down-draft and/or slag collection systems.

U.S. Pat. No. 4,058,299 discloses a cutting table with a suction unit that is positioned below the material being cut and is movable with the cutters, which are positioned above the material being cut. U.S. Pat. No. 6,165,410 discloses a cutting torch positioned above an elongated table and movable along the length of the table to cut material positioned on the table. An elongated exhaust duct is positioned beneath the table and runs parallel to the length of the table. The exhaust duct has a plurality of horizontally spaced-apart exhaust openings formed therein which are each closed by a respective movable damper. Successive dampers are opened as a slag collection bucket moves along the length of the table below the cutting torch.

Although tables for use in cutting and including moving collection systems are known, there is always a need for improved systems.

### BRIEF SUMMARY OF SOME ASPECTS OF THE INVENTION

One aspect of the present invention relates to a table that is for supporting a workpiece while the workpiece is being cut in a manner that produces residue such as fumes and/or slag. The table includes a pervious partition having an upper surface for supporting the workpiece while the workpiece is being cut. The pervious partition has a length extending in a longitudinal direction and a width extending in a lateral direction which is perpendicular to the longitudinal direction. The table further includes a receptacle positioned below the pervious partition for collecting at least some of the residue which passes through the previous partition. The receptacle is mounted for back and forth movement in the longitudinal direction relative to the pervious partition, so that the receptacle can be moved into optimal positions beneath the pervious partition for collecting residue which passes through the previous partition. At least one actuator is mounted for causing the back and forth movement of the receptacle.

In accordance with one aspect of the present invention, a gantry is mounted for back and forth movement in the longitudinal direction above the pervious partition, a carriage is mounted to the gantry for back and forth movement in the lateral direction, and a cutting head is carried by and movable with the carriage. The cutting head is for cutting the workpiece while the workpiece is supported by the pervious partition. In accordance with this aspect, the receptacle defines a width which extends in the longitudinal direction and is substantially less than the length of the pervious partition, and a controller is operative for causing the actuator to operate in an advantageous manner. More specifically, and in one mode of operation, the system operates so that the receptacle moves back and forth in the longitudinal direction so as to remain substantially vertically aligned with the cutting head while the cutting head moves back and forth in the longitudinal direction.

In accordance with one aspect of the present invention, the receptacle is part of a down-draft system (e.g., a down-draft blower system) that is at least for drawing fumes downward through the pervious partition. In accordance with this aspect, the down-draft system further includes a duct that extends in the longitudinal direction. The duct can be positioned below the receptacle so that the receptacle extends at least partially across an upper surface of the duct. The duct is in fluid communication with the receptacle so that at least some of the fumes can be drawn along a fume-drawing flow path which extends through the pervious partition and then into the duct by way of the receptacle. In one example, the receptacle preferably extends completely across an upper surface of the duct in the lateral direction. This arrangement can be advantageous because, for example, it is space-efficient and allows the length of the receptacle to be substantially matched to the width of the pervious partition, which optimizes the collecting of residue (e.g., fumes and slag) in the receptacle.

In accordance with one aspect of the present invention, the table includes a frame having a plurality of beams that extend in the longitudinal direction and carry the pervious partition, and it is preferred for the beams to also carry the receptacle. In accordance with one example of this aspect, each of the beams includes an integral flange which protrudes in the lateral direction and extends in the longitudinal direction, and the receptacle is carried by the flanges for facilitating the back and forth movement of the receptacle. More specifically, and in one example, the receptacle includes a plurality of upper rolling mechanisms which respectively travel along upper surfaces of the flanges, and a plurality of lower rolling mechanisms which respectively travel along lower surfaces of the flanges, and at least one of these rolling mechanisms is connected to and driven by the actuator. Preferably the frame includes structures which are respectively mounted below the beams and support the beams so that the beams are elevated above the floor which supports the frame. At least partially as a result, the receptacle is likewise preferably elevated above the floor.

In accordance with one aspect of the present invention, the receptacle includes both a container defining an upper opening, and an upwardly open trough for collecting any slag passing through the pervious partition. In accordance with one embodiment of the present invention, the trough is removably mounted to the container so that the trough can be lifted out of the container to facilitate removal of slag and any other residue which has accumulated in the trough. In accordance with one embodiment of the present invention, the table does not include the down-draft system, but it does include the automatically moving receptacle/trough for collecting slag and any other residue which passes through the pervious partition. In accordance with another embodiment in which the receptacle/trough is part of the down-draft system, the trough is removably mounted to the container so that: the trough at least partially covers the upper opening of the container, and a portion of the trough and a portion of the container are in opposing face-to-face relation so that a chamber is at least partially defined therebetween. Further in accordance with this embodiment, the trough defines inlet opening(s) through which the fume-drawing flow path enters the chamber, and the container defines an outlet opening through which the fume-drawing flow path exits the chamber.

In accordance with one aspect of the present invention, the down-draft system further includes a passageway by way of which the duct is in the fluid communication with the receptacle. That is, the fume-drawing flowpath extends through the passageway, with the receptacle being upstream from the passageway and the duct being downstream from the passageway. In accordance with one example of this aspect, the passageway is mounted to the receptacle so that the passageway extends downwardly from a bottom surface of the receptacle and moves with the receptacle during the back and forth movement of the receptacle. The outlet end of the passageway penetrates the duct by sliding beneath and opening a portion of a longitudinally extending flap of the duct. Preferably a length of the duct that is penetrated by the mouth, and most preferably the entire length of the duct that is penetrated by the mouth, is lying on, and fastened to, the floor which supports the frame of the table. The outlet end of the passageway can be equipped with an elongate protrusion which preferably seals against, or is at least in close proximity to, a seating surface of the duct. A margin of the flap engages the seating surface while the flap (e.g., a portion of the flap) is closed. The seating surface can extend obliquely, and the outlet end of the passageway can have obliquely angled leading edges for lifting the flap away from the seating surface of the duct. In addition, the outlet end of the passageway can define multiple oppositely oriented curves for advantageously enhancing the opening and closing of the flap.

In accordance with one aspect of the present invention, the back and forth movement of the receptacle is controlled by a controller to provide at least two modes of operation. In an automatic mode of operation, the receptacle preferably moves so as to remain in the same vertical plane with the cutter of the gantry-style cutting system associated with the table. In a manual mode of operation, the position of the receptacle can be changed independently of the gantry-style cutting system. The controller for the receptacle can be the same controller that is used for controlling the gantry-style cutting system, or it can be a portion of that controller, or some how in communication with that controller. On the other hand, the controller for the receptacle can be a controller that is separate from the controller for the gantry-style cutting system, such as by being a separate programmable logic controller that communicates with a sensor mounted for determining the position of the gantry-style cutting system.

In accordance with one aspect of the present invention, a switch is positioned for detecting when the gantry-style cutting system travels beyond an end of the table, such as for being serviced. When the switch is initially triggered by one of the uprights of the gantry-style cutting system as it moves past a point proximate an end of the table, the controller responds to the triggering by ceasing the automatic movement of the receptacle. In accordance with this example, the automatic movement of the receptacle is reinitiated when the switch is triggered as a result of the gantry-style cutting system traveling from a position that is distant from the table, back to a position in which the gantry-style cutting system is vertically aligned with the table.

Each of, and combinations of, the foregoing and other aspects of the present invention provide advantages.

### BRIEF DESCRIPTION OF THE DRAWINGS

Having thus described the invention in general terms, reference will now be made to the accompanying drawings, which are not necessarily drawn to scale, and wherein:

FIG. 1 is a partially cut-away, partially schematic, pictorial view which illustrates a workpiece that is positioned on a table so that the workpiece can be cut by an associated gantry-style cutting system, in accordance with an exemplary embodiment of the present invention;

FIG. 1a is an isolated, cross-sectional view of portions of a representative carrying mechanism that is for facilitating back and forth movement of a receptacle of a down-draft system of the table of FIG. 1, with the cross-section taken along line 1a-1a of FIG. 1;

FIG. 2 is an isolated, exploded pictorial view of the receptacle;

FIG. 3 is an isolated, cross-sectional view of the receptacle in an assembled configuration, with the cross-section taken substantially along line 3-3 of FIG. 2;

FIG. 4 is an isolated pictorial view of a passageway carried by the receptacle, in accordance with the exemplary embodiment of the present invention;

FIG. 5 is an isolated, partially exploded view of a representative section of a duct of the down-draft system of FIG. 1;

FIG. 6 is an isolated, pictorial view of the passageway mated to the duct, with a portion of the duct cut away, in accordance with the exemplary embodiment of the present invention;

FIG. 7 is a partially schematic, cross-sectional view taken along line 7-7 of FIG. 6, with an additional portion of a flap cut away to clarify the view, and further illustrating the duct laying upon and fastened to a floor which supports the table and cutting system, in accordance with the exemplary embodiment of the present invention;

FIG. 8 is an isolated, pictorial view of a representative portion of a channel of a duct of a down-draft system, in accordance with a second embodiment of the present invention; and

FIG. 9 is an isolated, cross-sectional view of the duct of the down-draft system of the second embodiment of the present invention, with the flap of the duct fully closed, and further illustrating the duct laying upon and fastened to a floor which supports the table and cutting system of the second embodiment of the present invention.

### DETAILED DESCRIPTION OF THE INVENTION

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

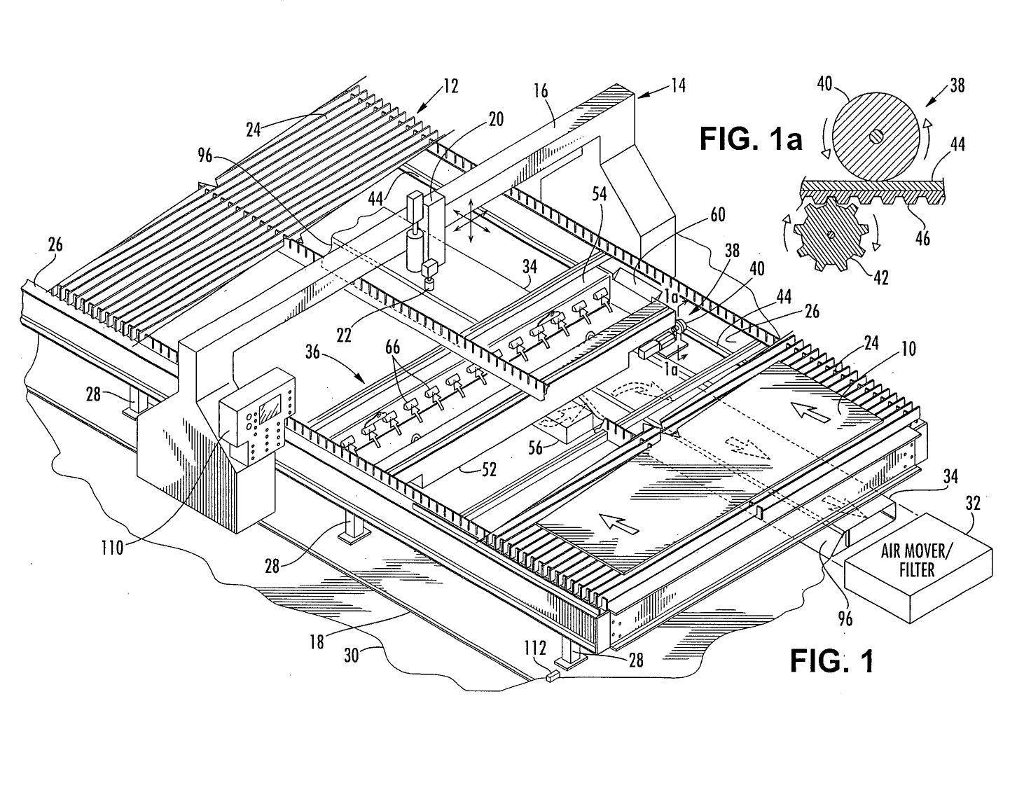

As illustrated in FIG. 1, a workpiece 10 is positioned on a table 12 having a down-draft system, so that the workpiece can be cut by a cutting system 14 in a manner which produces residue such as fumes. The workpiece 10 is preferably a piece of metal, although other workpieces are also within the scope of the present invention. Although a wide variety of cutting systems are within the scope of the present invention, the cutting system 14 of FIG. 1 includes: a conventional gantry 16 that is positioned above the table 12 and can travel back and forth in a longitudinal direction along tracks 18, a conventional carriage 20 mounted to the gantry for back and forth movement in a lateral direction which is perpendicular to the longitudinal direction, and a conventional cutting head 22 that is for cutting the workpiece 10. The cutting head 22 is carried by and movable with the carriage 20. Although only one cutting head 22 and one carriage 20 are shown in FIG. 1, there can be multiple carriages and accompanying cutting heads carried by the same gantry 16. In accordance with the exemplary embodiment of the present invention, the cutting head 22 is for plasma arc cutting, but alternatively it could be for cutting with a burning fuel such as acetylene, cutting with a laser cutting head, or performing any other type of cutting which creates fumes or other types of residue which can be collected using one or more features of the table 14.

In accordance with the exemplary embodiment of the present invention, the table includes a pervious partition 24 having an upper surface for supporting the workpiece 10 while the workpiece is being cut. The pervious partition 24 can be metal grating, a series of metal slats, or any other structure or structures suitable for supporting the workpiece 10 while it is being cut using the cutting system 14. The pervious partition 24 is supported by a frame which is preferably constructed of steel and includes longitudinally extending beams 26 that are spaced apart from one another in the lateral direction. The pervious partition 24 preferably extends uniformly for substantially the entire length and width of the frame, is replaceable, and can be removed from the frame in sections. A large portion of the pervious partition 24 has been cut away in FIG. 1 to clarify the view. In accordance with the exemplary embodiment of the present invention, the beams 26 are I-beams which are respectively mounted atop pedestals 28. The pedestals 28 support the beams 26 above the floor 30 which supports the table 12. Other shapes of beams 26 are also within the scope of the present invention.

The down-draft system of the exemplary embodiment is for drawing downward and collecting at least some of the fumes resulting from operation of the cutting system 14. The down-draft system includes a conventional air mover 32 which is preferably equipped with a conventional filter or filtering system. The air mover 32 is in fluid communication with a duct 34 and a receptacle 36 for creating a fume-drawing flow path which extends into the receptacle, through the duct, and to the air mover, while the air mover is operating. That is, fumes resulting from operation of the cutting system 14 are drawn into the receptacle 36, through the duct 34, and to the air mover 32, while the air mover is operating and the receptacle is at least about vertically aligned with the gantry 16.

In one mode of operation of the exemplary embodiment of the present invention, the receptacle 36 automatically moves back and forth in the longitudinal direction with the gantry 16, so that the receptacle remains optimally positioned for enabling the down-draft system to collect at least some of the fumes and any other residue resulting from operation of the cutting system 14. In accordance with the exemplary embodiment of the present invention, the receptacle 36 extends at least partially across an upper surface of the duct 34, and preferably the receptacle extends completely across an upper surface of the duct in the lateral direction. This arrangement is advantageous because, for example, it is space-efficient and allows the length of the receptacle 36 to be substantially matched to the width of the pervious partition 24, which optimizes the drawing down of fumes and other residue into the receptacle. This also helps to maximize the amount of non-gaseous residue, such as slag, that is collected in the receptacle 36. Other arrangements are also within the scope of the present invention.

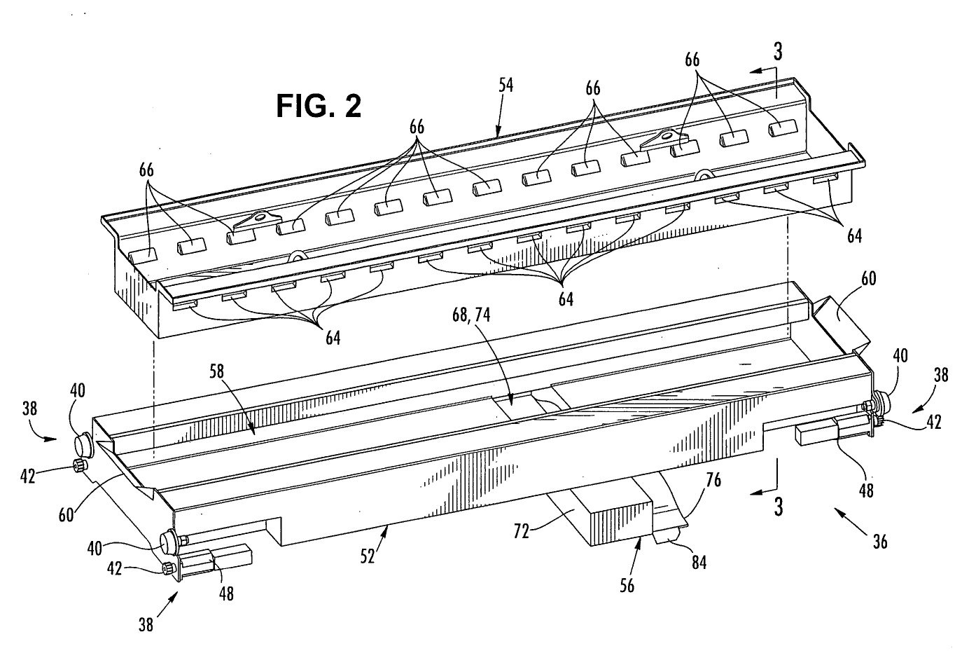

As partially illustrated in FIGS. 1 and 1 a, the back and forth movement of the receptacle 36 is preferably facilitated, in part, by four carriage mechanisms 38 which carry the receptacle 36 along the beams 26. As partially illustrated in FIG. 2, the carriage mechanisms 38 are preferably respectively located proximate the four corners of the receptacle 36. More specifically, the receptacle 36 includes opposite ends which are spaced apart from each other in the lateral direction, and there are preferably two of the carriage mechanisms 38 at each of the opposite ends. The receptacle 36 includes opposite sides which are spaced apart from each other in the longitudinal direction, and at each end of the receptacle, the carriage mechanisms 38 are preferably proximate the opposite sides.

As best understood with reference to FIG. 1a, and in accordance with the exemplary embodiment of the present invention, each of the carriage mechanisms 38 includes upper and lower rolling mechanisms 40, 42. A representative one of the carriage mechanisms 38 will now be described. The upper rolling mechanism 40 is connected to the receptacle 36 by a shaft and rolls along the upper surface of a lower, inwardly-oriented flange 44 of the respective I-beam 26. The lower rolling mechanism 42 is connected to the receptacle 36 by a shaft and rolls along the lower surface of the respective flange 44. In accordance with the exemplary embodiment of the present invention, gear racks 46 are respectively mounted to the lower surfaces of the inwardly-oriented flanges 44 of the beams 26, and the lower rolling mechanisms 42 are gears which are respectively meshed with the gear racks.

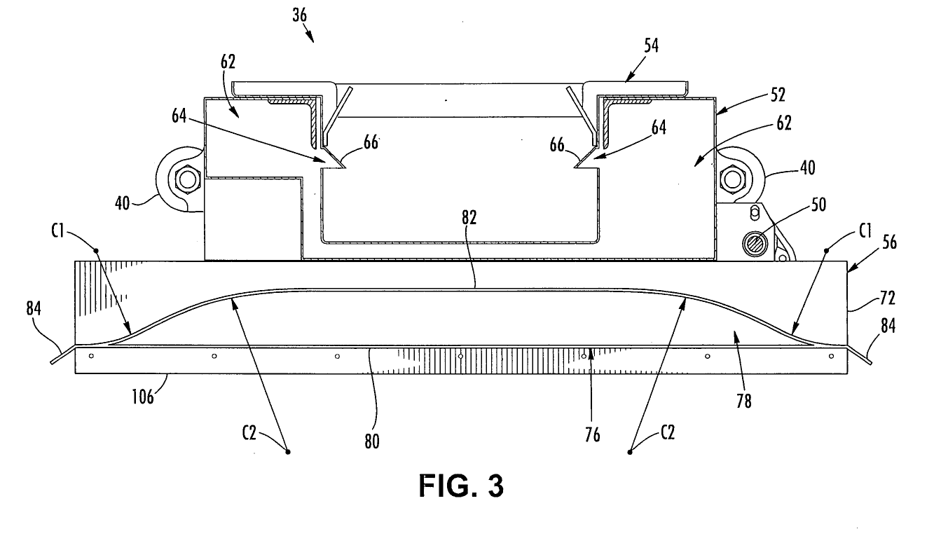

Referring to FIGS. 1 and 2, at least one of the gears 42 is driven by an actuator 48 which is preferably in the form of an electric motor. In some situations another of the gears 42 may also be driven by another actuator 48 which is in the form of an electric motor, or the like. As illustrated in FIG. 2, the two driven gears 42 are proximate one side of the receptacle 36. As best understood with reference to FIG. 3, the two gears 42 proximate the other side of the receptacle 36 are not driven, but they are both mounted to the same axle 50.

In accordance with the exemplary embodiment of the present invention, for each beam 26, its flange 44, which cooperates with (e.g. carries) two of the carriage mechanisms 38, is an integral part of the beam as a result of the beam being originally formed (e.g., such as by extrusion and/or forging and/or stamping and/or bending) to include the flange. This advantageously enhances the strength of the table 12 and provides for efficient assembly of the table and down-draft system.

As best understood with reference to FIG. 2, the receptacle 36 preferably includes a container 52 fitted with a trough 54 and passageway 56. The container 52 defines an upper opening 58, and the trough 54 is removably mounted to the container so that the trough at least partially covers the upper opening. The trough 54 is upwardly open for collecting any heavy residue, such as slag, that falls through the pervious partition 24 (FIG. 1) as a result of operation of the cutting system 14 (FIG. 1). The container 52 preferably includes deflectors 60 which extend obliquely for deflecting any slag falling thereupon into the trough 54. As best understood with reference to FIG. 1, the deflectors 60 advantageously function in a manner which seeks to prevent non-gaseous residue from accumulating upon the flanges 44 that the carriage mechanisms 38 travel upon.

Referring to FIGS. 2 and 3, the trough 54 fits into and closes the upper opening 58 of the container 52. In this closed configuration which is illustrated in FIG. 3, a portion of the trough 54 and a portion of the container 52 are in opposing face-to-face relation, so that a chamber 62 is defined therebetween. The trough 54 includes two laterally extending series of inlet openings 64 that are open to the chamber 62. Each of the inlet openings 64 is preferably covered by deflector 66. Each of the inlet openings 64 of one of the series is hidden from view behind their respective deflectors 66 in FIGS. 1 and 2. The deflectors 66 advantageously function in a manner which seeks to prevent non-gaseous residue from passing into the chamber 62 within the receptacle 36. In accordance with another embodiment of the present invention, a separate deflector 66 is not used for each inlet opening 64. Rather, for each series of inlet openings 64, a single, continuous deflector strip covers the inlet openings of the series.

As best understood with reference to FIGS. 2 and 3, the fume-drawing flow path extends through the inlet openings 64 of the trough 54, into the chamber 62, and then out of the chamber via an outlet opening 68 (FIG. 2) in the bottom of the container. As illustrated in FIG. 2, the outlet opening 68 is preferably located at a position that is between and distant from the opposite ends of the container 52. In accordance with the exemplary embodiment of the present invention, this advantageously seeks to substantially equalize the flow into each of the inlet openings 64. Other arrangements of the outlet opening 68 are also within the scope of the present invention.

In accordance with the exemplary embodiment of the present invention, and as best understood with reference to FIGS. 1, 6 and 7, the receptacle 36 is in the fluid communication with the duct 34 by way of the passageway 56, which extends downwardly from the container 52. The passageway 56 is preferably mounted to the container 52 for traveling back and forth as part of the receptacle 36. On the other hand, the passageway 56 can be characterized as being a component which is not a part of the receptacle but which is mounted to and travels with the receptacle. As best understood with reference to FIGS. 2-4, an upstream portion of the passageway 56 is preferably in the form of a rectangular box 72 which is mounted to a bottom surface of the container 52. The box 72 preferably has an upper inlet opening 74 (FIG. 2) which is in direct communication with the chamber 62 (FIG. 3) within the receptacle 36. The outlet end of the passageway 56 is preferably in the form of a wide mouth 76 which is mounted to a sidewall of the box 72. The mouth 76 communicates with the interior of the box 72 through an outlet opening 78 (FIG. 3) of the box which is defined through the sidewall of the box and surrounded by the mouth.

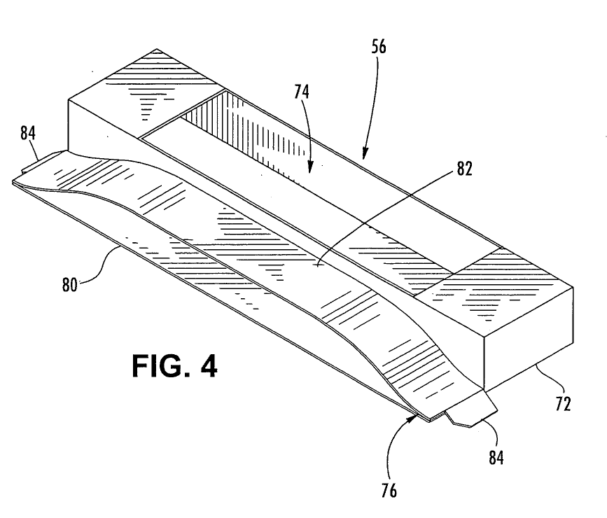

In accordance with the exemplary embodiment of the present invention, and as best understood with reference to FIGS. 3 and 4, the mouth 76 includes a planar bottom surface 80 and a curved top surface 82, each of which extend between opposite sides of the mouth. The opposite sides of the mouth 76 are preferably mirror images of one another. The curved top surface 82 is shaped so that each of the sides of the mouth 76 tapers so as to become narrower at increasing distance from the other side. Each of the sides of the mouth 76 preferably terminates at a protrusion 84. As best understood with reference to FIG. 3, proximate each of the sides of the mouth 76, the curved top surface 82 preferably defines two curves respectively having centers of curvature C1 and C2 which are positioned on opposite sides of the bottom surface 80 of the mouth. The curves of the top surface 82 advantageously enable the mouth 76 to interact with the duct 34 (FIGS. 1 and 5-7) in an at least generally leak-free manner, as will be discussed in greater detail below. Differently shaped mouths are also within the scope of the present invention.

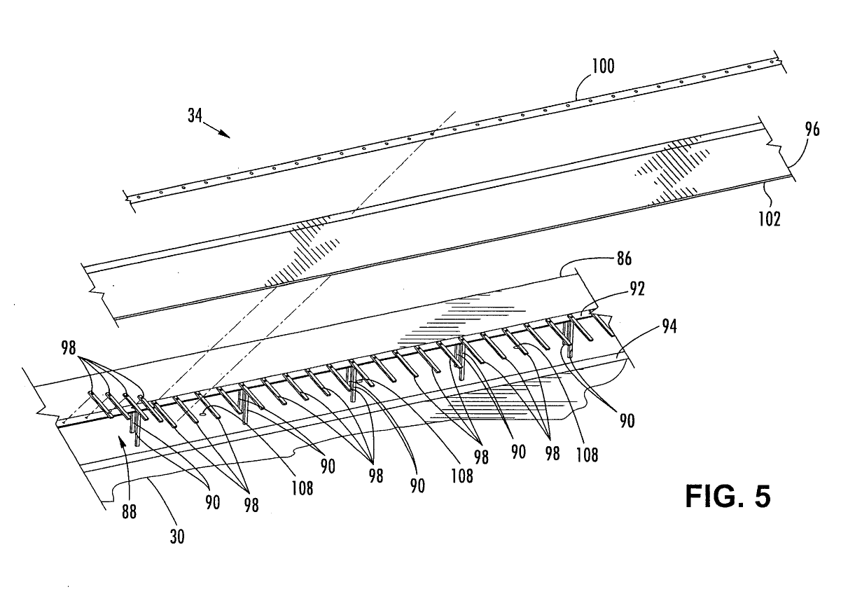

Referring to FIG. 5, the duct 34 of the exemplary embodiment of the present invention includes a longitudinally extending channel 86 that is open (i.e., defines a channel opening 88) along one side. The channel 86 can be reinforced by internal upright supports 90. In accordance with the exemplary embodiment of the present invention, the duct 34 extends for, and is substantially uniform along, the entire length of the table 12, and likewise the channel opening 88 extends along, and is substantially uniform along, the entire length of the table. That is, and in accordance with the exemplary embodiment of the present invention, the channel 86 includes only one channel opening 88, which extends for substantially the entire length of the table 12.

Preferably the channel 86 and the other components of the table 12 and down-draft system of the present invention which have been discussed above in this Detailed Description section of this discloser are constructed of metal, except as would be understood by those of ordinary skill in the art. For example, any conventional filter associated with the conventional air mover 32 (FIG. 1) may include fiberglass or paper filtering mediums, or any other type of conventional filter medium.

As illustrated in FIG. 5, the open side of the channel 86 has an upper, obliquely angled mounting surface 92, and a lower, obliquely angled seating surface 94. An upper margin of an elongate flexible flap 96 is mounted to the mounting surface 92. The flexible flap 96 preferably is a single piece which is substantially uniform along its length and extends for substantially the entire length of the table 12, for covering and closing the channel opening 88. The flap 96 can be reinforced with a series of reinforcing supports 98 and secured to (i.e., sealed against) the mounting surface 92 by fasteners and a reinforcing strip 100. The flexible flap 96 is preferably a polymeric material, and is most preferably natural gum rubber, or the like. The reinforcing supports 98 are preferably constructed of metal.

The lower margin 102 of the flap 96 preferably seats securely against the seating surface 94 of the channel 86. In accordance with the exemplary embodiment of the present invention, the resilience of the flap 96, gravity, and the partial vacuum within the duct 34 (which occurs while the air mover 32 is operating) bias the flap toward the configuration in which the lower margin 102 of the flap seats against and is sealed against the seating surface 94. Similarly, opposite ends of the flap 96 seal against other seating surfaces (not shown) of the channel 86 or are otherwise sealed against the channel so that the flap is for substantially closing and sealing the only inlet opening (i.e., the channel opening 88) to the channel. It is preferred for the air mover 32 (FIG. 1) to create a sufficient partial vacuum so that the lower margin 102 of the flexible flap 96 remains securely sealed against the seating surface 94, except where the mouth 76 (FIGS. 2-4, 6 and 7) is currently separating the lower margin of the flap 96 from the seating surface 94.

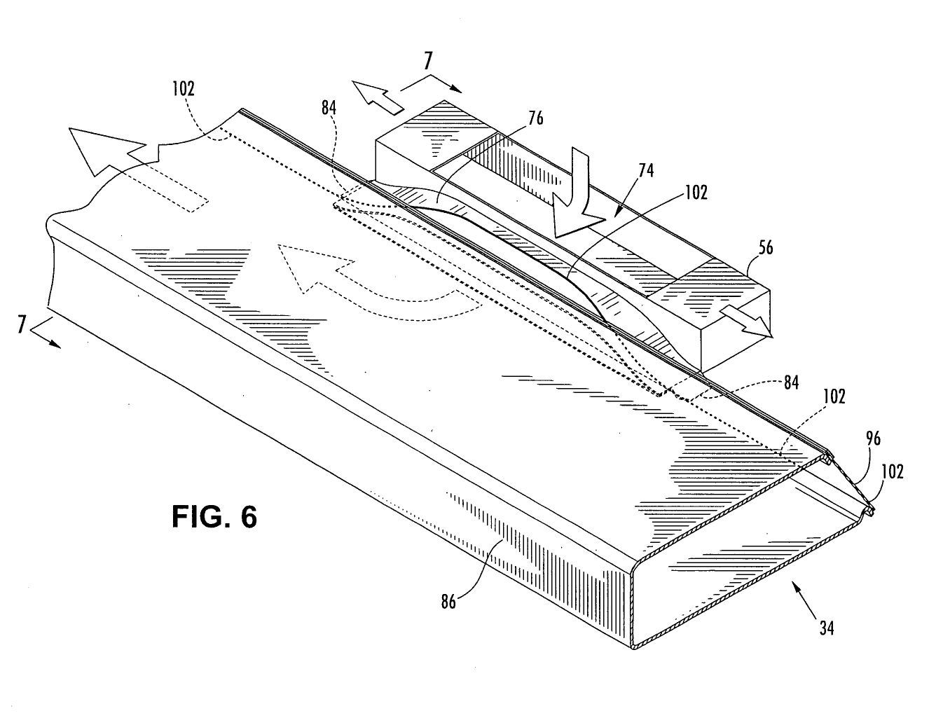

Referring primarily to FIG. 6, during operation of the down-draft system, it is preferred for the entirety of the lower margin 102 of the flap 96 to remain in a closed configuration (e.g., seated/sealed against the seating surface 94 of the channel 86), except where the mouth 76 causes the flap to be in an opened configuration (e.g., the mouth is positioned between the lower margin of the flap and the seating surface of the channel). More specifically, the mouth 76 moves with the receptacle 36 (FIGS. 1-3) in the longitudinal direction relative to the duct 34 so that the mouth sequentially engages portions of the flap 96 and thereby temporarily moves the respective portion of the flap from the closed configuration to the open configuration, so the interior of the mouth is open to the interior of the duct. That is, the fume-drawing flow path extends through the mouth 76 and travels with the mouth.

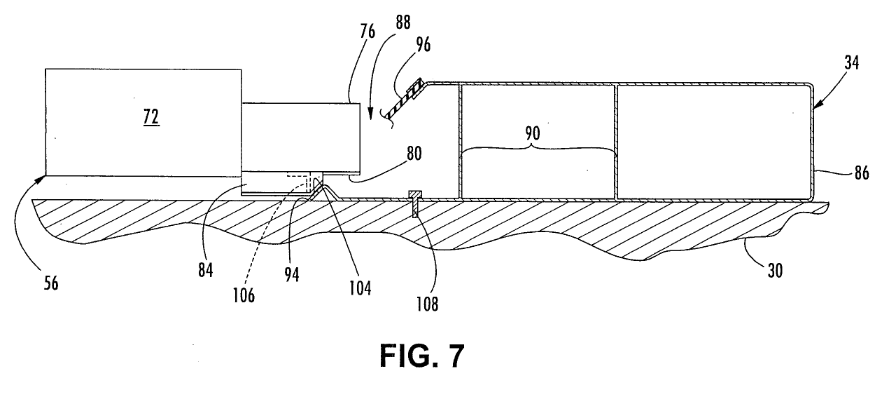

As illustrated in FIG. 6, one side of the mouth 76 separates the lower margin 102 of the flap 96 from the seating surface 94 (FIG. 5) of the channel 86 as the receptacle 36 (FIGS. 1-3) and the mouth move toward one end of the table 12 (FIG. 1). Likewise the other side of the mouth 76 separates the lower margin 102 of the flap 96 from the seating surface 94 of the channel 86 as the receptacle 36 and the mouth move toward the other end of the table. As best understood with reference to FIG. 7, for each of the sides of the mouth 76, it is preferred for an obliquely angled leading edge 104 of the protrusion 84 to be in opposing face-to-face relation with, and in contact with or only slightly separated from, the obliquely angled seating surface 94, so that the leading edge lifts the lower margin 102 (FIGS. 5 and 6) of the flap 96 from the seating surface. The protrusions 84 and their leading edges 104 advantageously seek to prevent the sides of the mouth 76 from becoming jammed against the flap 96. However, other measures can be taken to prevent such jamming.

Referring to FIGS. 3 and 7, a protrusion 106 extends downwardly from the bottom surface 80 of the mouth 76, in accordance with the exemplary embodiment of the present invention. The protrusion extends 106 in the longitudinal direction from proximate one of the sides of the mouth 76 to the other of the sides of the mouth, and a lower edge of the protrusion 106 is at least proximate the seating surface 94 of the duct 34 to restrict bypass flow. The protrusion 106 is preferably a strip of polymeric material, and most preferably a strip of natural gum rubber, or the like, which is attached to the bottom surface of the mouth 76 with a piece of angle iron, or the like.

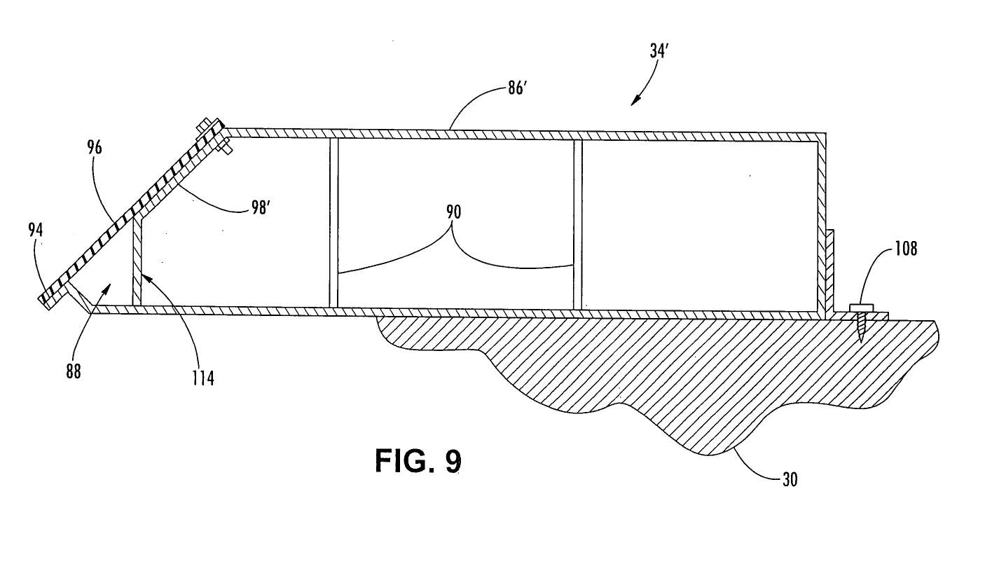

As best understood with reference to FIGS. 5 and 7, a length of the duct 34 that is penetrated by the mouth 76, and most preferably the entire length of the duct that is penetrated by the mouth, is lying on the floor 30 which supports the frame of the table 12 (FIG. 1), in accordance with the exemplary embodiment. It is preferred for the portion of the duct 34 that is lying upon the floor 30 to be fastened to the floor by fasteners 108, such as bolts or screws, which extend through the lower surface of the channel 86 and into the floor. Alternatively, the fasteners 108 can extend through brackets connected to the channel 86, as illustrated in FIG. 9. If the floor 30 is not sufficiently level, shims can be used between the channel 86 and the floor and/or between the frame's pedestals 28 (FIG. 1) and the floor to bring the mouth 76 and the opening 88 of the channel 86 into good alignment with one another.

Aspects of operation of the table 12 and its down-draft system will now be described, in accordance with the exemplary embodiment of the present invention. The back and forth movement of the receptacle 36 is preferably controlled by a controller to provide at least two modes of operation. In an automatic mode of operation, the receptacle 36 moves simultaneously with the gantry 16 so that the center line of the receptacle substantially remains in the same vertical plane with the cutter 22 carried by the gantry. In a manual mode of operation, the position of the receptacle 36 can be changed independently of the gantry-style cutting system 14. The manual mode may be used to park the receptacle 36 at a position distant from the gantry 16, such as at an end of the table 12. With the receptacle 36 parked in this manner, the portion of the pervious partition 24 above the receptacle can be removed so that nongaseous residue collected in the trough 54 can be removed from the trough. This can be facilitated, in part and for example, by lifting the trough 54 out of and away from the container 52.

The controller 110 (FIG. 1) for the receptacle 36 can be the same controller that is used for controlling the gantry-style cutting system 14, or it can be a portion of that controller, or some how in communication with that controller. On the other hand, the controller for the receptacle 36 can be a controller that is separate from the controller 110 for the gantry-style cutting system 14, such as by being a programmable logic controller that communicates with a sensor mounted for determining the position of the gantry 16.

In accordance with one version of the exemplary embodiment of the present invention, a switch 112 (FIG. 1) is positioned for detecting when the gantry 16 travels beyond an end of the table 12, such as for being serviced. When the switch 112 is initially triggered by one of the uprights carrying the gantry 16 as it moves past a point proximate an end of the table 12, the controller 110 responds to the triggering of the switch by ceasing automatic movement of the receptacle 36. In accordance with this example, the automatic movement of the receptacle 36 is reinitiated when the switch 112 is triggered as a result of the gantry 16 traveling from a position that is distant from the table 12, back to a position in which the gantry is vertically aligned with the table.

In accordance with the exemplary embodiment of the present invention, the longitudinally extending side beams 26 and laterally extending end beams of the table 12 are preferably respectively releasably fastened to one another with nuts and bolts, or the like, while the table is fully assembled. Thus, the table 12 and associated equipment can be conveniently shipped in a disassembled configuration in which the beams (e.g., beams 26) are unbolted from one another. The receptacle 36 can be conveniently shipped in its fully assembled configuration, with its associated components mounted thereto, such as the carriages 20 and the passageway 56. Thereafter, the table can be conveniently assembled.

An alternative embodiment of the present invention is like the exemplary embodiment, except that this alternative embodiment further includes engagement mechanisms (not shown) for aiding in closing the flap 96 of the duct 34. The engagement mechanisms are mounted for traveling with the receptacle 36 in the longitudinal direction relative to the flap 96. The engagement mechanisms sequentially engage the portions of the flap 96 that are adjacent the ends of the mouth 76 to urge the flap to the closed configuration. It is preferred for one of the engagement mechanisms to be proximate each of the sides of the mouth 76. The flap 96 extends under the first engagement mechanism and then over the first side of the mouth 76, and the flap extends over the second side of the mouth and then under the second engagement mechanism. The engagement mechanisms can each be in the form of a roller.

Another alternative embodiment of the present invention resembles the exemplary embodiment, except that this alternative embodiment further includes doors (not shown) at the ends of the receptacle 36 so that the slag can be removed from the receptacle via the doors. In this embodiment, a bottom surface of the receptacle 36 can be inclined downwardly in the lateral direction so that slag which falls into the receptacle will have a tendency to travel toward the doors, or will at least be easier to urge toward the doors.

In accordance with another alternative embodiment of the present invention, the table includes three longitudinally extending I-like beams, with pervious partitions thereabove. The three beams preferably extend parallel to one another in the longitudinal direction and are spaced apart from one another in the lateral direction. A first down-draft system is associated with an outer one of the beams (i.e., first beam) and a middle one of the beams (i.e., middle beam), and a second down-draft system is associated with the other outer beam (i.e., second beam) and the middle beam. Preferably the carriage mechanisms of the receptacle of the first down-draft system respectively travel upon: the lower flange on the side of the first beam which faces the middle beam, and the lower flange on the side of the middle beam which faces the first beam. Preferably the carriage mechanisms of the receptacle of the second down-draft system respectively travel upon: the lower flange on the side of the second beam which faces the middle beam, and the lower flange on the side of the middle beam which faces the second beam. Each of the down-draft systems of this alternative embodiment can be identical to the down-draft system of the exemplary embodiment, although it may be preferred for the ducts of the down-drafts systems of this alternative embodiment to be in fluid communication with a common header that is connected to a single air mover.

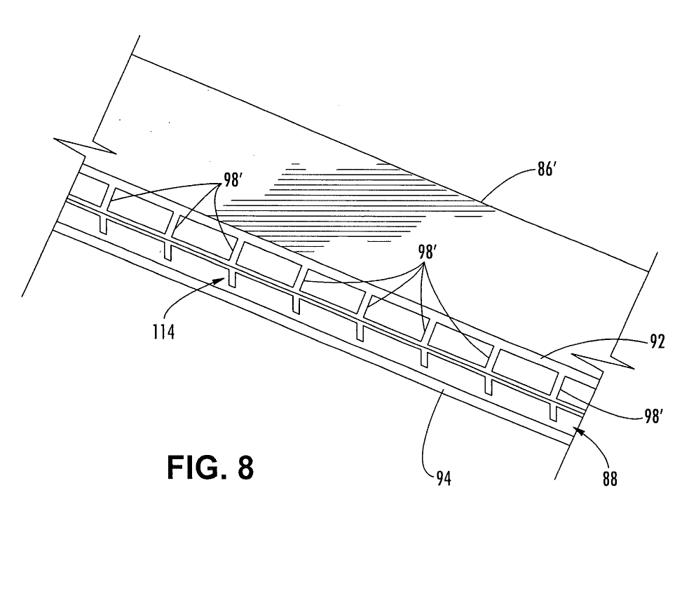

A second embodiment of the present invention is identical to the exemplary embodiment of the present invention, except for variations noted herein and variations that will be apparent to those of ordinary skill in the art in view of this disclosure. As best understood with reference to FIG. 8, rather than using separate reinforcing supports 98 (FIG. 5) as in the exemplary embodiment, the reinforcing supports 98′ are integral with the channel 86′ of the duct 34′ (FIG. 9) of the down-draft system, in accordance with the second embodiment of the present invention. More specifically in accordance with the second embodiment, the reinforcing supports 98′ are part of a grid 114 that is cut into the material of the channel 86′ and is integral with the channel. As best understood with reference to FIG. 9, the reinforcing supports 98′ of the grid 114 preferably extend obliquely, as extensions of the mounting surface 92 (FIG. 8). In addition, optional lower portions of the grid 114 extend vertically and contact the floor of the channel 86′ in a manner that provides support to the reinforcing supports 98′.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A table that is for supporting a workpiece while the workpiece is being cut in a manner that produces fumes, the table comprising:
a pervious partition having an upper surface for supporting the workpiece while the workpiece is being cut, with the pervious partition having a length extending in a longitudinal direction and a width extending in a lateral direction which is perpendicular to the longitudinal direction;
a down-draft system for drawing at least some of the fumes downward through the pervious partition, with the down-draft system including a receptacle positioned below the pervious partition, and a duct that extends in the longitudinal direction, wherein the duct is in fluid communication with the receptacle so that at least some of the fumes can be drawn along a flow path which extends through the pervious partition and then into the duct by way of the receptacle, and the receptacle is mounted for back and forth movement in the longitudinal direction relative to the pervious partition and the duct; and
first and second beams that are spaced apart from one another in the lateral direction and extend in the longitudinal direction, wherein the first and second beams carry both the pervious partition and the receptacle, and wherein the receptacle includes:
opposite first and second ends which are spaced apart from one another in the lateral direction,
a first carrier mounted to the first end for carrying the first end back and forth in the longitudinal direction along the first beam, and
a second carrier mounted to the second end for carrying the second end back and forth in the longitudinal direction along the second beam.

2. The table according to claim 1, wherein the duct is distant from each of the first and second beams.

3. The table according to claim 1, wherein:
the first and second beams are part of a frame that carries the pervious partition and is positioned upon a floor;
the duct is in fluid communication with the receptacle by way of a mouth that penetrates the duct and is movable back and forth with the receptacle relative to the duct; and
a length of the duct that is penetrated by the mouth is lying on the floor.

4. The table according to claim 1, further comprising:
an air mover in fluid communication with the duct for creating a partial vacuum in the duct and the receptacle;
a cutting system including:
a gantry mounted for back and forth movement in the longitudinal direction above the pervious partition,
a carriage mounted to the gantry for back and forth movement in the lateral direction above the pervious partition, and
a cutting head that is for cutting the workpiece while the workpiece is supported by the pervious partition, with the cutting head being carried by and movable with the carriage; and
an actuator mounted for causing the back and forth movement of the receptacle,
wherein:
the receptacle defines a width which extends in the longitudinal direction and is substantially less than the length of the pervious partition, and
the actuator includes:
a motor for moving the receptacle in the longitudinal direction relative to the pervious partition and the duct, and
a controller for causing the motor to operate, and thereby move the receptacle in the longitudinal direction, in a manner such that receptacle remains substantially vertically aligned with the cutting head while the cutting head moves in the longitudinal direction and cuts the workpiece.

5. The table according to claim 1, wherein each of the beams includes a flange which protrudes in the lateral direction and extends in the longitudinal direction, the first carrier of the receptacle travels upon the flange of the first beam and carries the receptacle along the flange of the first beam, and the second carrier of the receptacle travels upon the flange of the second beam and carries the receptacle along the flange of the second beam.

6. The table according to claim 5, wherein the receptacle includes a plurality of deflectors for diverting any falling residue, which results from cutting of the workpiece, in a manner which seeks to prevent the residue from accumulating upon the flanges, and wherein the deflectors travel with the receptacle and respectively extend obliquely over the flanges.

7. The table according to claim 1, wherein the duct is positioned below the receptacle so that the receptacle extends at least partially across an upper surface of the duct.

8. The table according to claim 7, wherein the receptacle extends completely across an upper surface of the duct in the lateral direction.

9. The table according to claim 1, wherein the receptacle includes:
an inlet opening through which the flow path enters the receptacle, and
an outlet opening through which the flow path exits the receptacle, wherein the outlet opening is located at a position that is between the opposite fist and second ends of the receptacle and distant from each of the opposite first and second ends of the receptacle.

10. The table according to claim 9, wherein the receptacle further includes:
a container defining an upper opening, and
an upwardly open trough for collecting any slag passing through the pervious partition, wherein the trough defines the inlet opening, and the trough is removably mounted to the container so that the trough at least partially covers the upper opening.

11. The table according to claim 10, wherein:
the container defines the outlet opening through which the flow path exits the container, and
a portion of the trough and a portion of the container are in opposing face-to-face relation so that a chamber is at least partially defined therebetween, with the flow path extending through the chamber from the inlet opening of the trough to the outlet opening of the container.

12. The table according to claim 1, further comprising a passageway by way of which the duct is in the fluid communication with the receptacle, wherein:
the duct includes:
an elongate inlet opening which extends in the longitudinal direction, and
an elongate flexible flap which extends in the longitudinal direction and is biased toward a closed configuration in which the flap closes the inlet opening; and
the passageway is mounted to the receptacle for moving with the receptacle in the longitudinal direction relative to the duct so that an outlet end of the passageway sequentially engages portions of the flap and thereby temporarily moves the portions of the flap from the closed configuration to an open configuration so that portions of the inlet opening are temporarily opened as the passageway moves in the longitudinal direction relative to the duct, so that the flow path enters the duct through the opened portions of the inlet opening.

13. The table according to claim 12, wherein:
the passageway includes a protrusion which extends downwardly from a bottom surface of the outlet end of the passageway,
the protrusion extends in the longitudinal direction from proximate a first side of the outlet end of the passageway to proximate a second side of the outlet end of the passageway, and
an edge of the protrusion is at least proximate to a seating surface of the duct.

14. The table according to claim 12, wherein:
the outlet end of the passageway includes opposite first and second sides that are spaced apart from one another in the longitudinal direction,
the flap extends over the outlet end of the passageway and the first and second sides of the outlet end of the passageway,
the first side of the outlet end of the passageway tapers so as to become narrow at increasing distance from the second side of the outlet end of the passageway,
the first side of the outlet end of the passageway separates a lower portion of the flap from a seating surface of the duct as the receptacle and the passage move in the longitudinal direction toward a first end of the table,
the second side of the outlet end of the passageway tapers so as to become narrow at increasing distance from the first side of the outlet end of the passageway, and
second first side of the outlet end of the passageway separates the lower portion of the flap from the seating surface as the receptacle and the passage move in the longitudinal direction toward a second end of the table.

15. The table according to claim 14, wherein:
the seating surface and the lower portion of the flap each extend in the longitudinal direction;
the longitudinal and lateral directions extend at least generally in a horizontal plane;
the seating surface extends obliquely relative to the horizontal plane; and
the first side of the outlet end of the passageway includes a first leading edge which separates the lower portion of the flap from the seating surface of the duct as the receptacle and the passageway move in the longitudinal direction toward the first end of the table.

16. The table according to claim 14, wherein:
the first side of the outlet end of the passageway tapers as a result of a first portion of a top of the outlet end of the passageway extending toward a bottom of the outlet end of the passageway; and
the second side of the outlet end of the passageway tapers as a result of a second portion of the top of the outlet end of the passageway extending toward the bottom of the outlet end of the passageway.

17. The table according to claim 16, wherein in a profile view of the first portion of the top of the outlet end of the passageway, the first portion of the top of the outlet end of the passageway defines two curves respectively having centers of curvature which are positioned on opposite sides of the bottom of the outlet end of the passageway.

18. A table that is for supporting a workpiece while the workpiece is being cut in a manner that produces residue, the table comprising:
a pervious partition having an upper surface for supporting the workpiece while the workpiece is being cut, with the pervious partition having a length extending in a longitudinal direction and a width extending in a lateral direction which is perpendicular to the longitudinal direction;
a frame having a plurality of beams that extend in the longitudinal direction and carry the pervious partition, wherein each of the beams includes an integral flange which protrudes in the lateral direction and extends in the longitudinal direction; and
a receptacle positioned below the pervious partition for collecting at least some of the residue which falls through the previous partition, wherein the receptacle includes a plurality of rolling mechanisms which respectively travel along the flanges, so that the receptacle is carried by the flanges for back and forth movement in the longitudinal direction relative to the pervious partition.

19. The table according to claim 18, further comprising:
a plurality of gear racks respectively mounted to the lower surfaces of the flanges, wherein the rolling mechanisms comprise gears that are respectively meshed with the gear racks; and
an actuator mounted for driving at least one of the rolling mechanisms for causing the back and forth movement of the receptacle.

20. The table according to claim 18, wherein the receptacle includes a plurality of deflectors for diverting any falling residue, which results from cutting of the workpiece, in a manner which seeks to prevent the residue from accumulating upon the flanges, wherein the deflectors travel with the receptacle and respectively extend obliquely over the flanges.

21. The table according to claim 18, wherein the plurality of rolling mechanisms includes:
a plurality of upper rolling mechanisms which respectively travel along upper surfaces of the flanges, and
a plurality of lower rolling mechanisms which respectively travel along lower surfaces of the flanges,
whereby the receptacle is mounted to the flanges for the back and forth movement of the receptacle.

22. The table according to claim 21, further comprising:
an actuator mounted for causing the back and forth movement of the receptacle; and
a plurality of gear racks respectively mounted to the lower surfaces of the flanges,
wherein:
the lower rolling mechanisms are gears that are respectively meshed with the gear racks, and
the actuator drives at least one of the gears for causing the back and forth movement of the receptacle.

23. A table that is for supporting a workpiece while the workpiece is being cut in a manner that produces fumes, the table comprising:
a pervious partition having an upper surface for supporting the workpiece while the workpiece is being cut, with the pervious partition having a length extending in a longitudinal direction and a width extending in a lateral direction which is perpendicular to the longitudinal direction; and
a down-draft system for drawing at least some of the fumes downward through the pervious partition, with the down-draft system including:
a receptacle positioned below the pervious partition and mounted for back and forth movement in the longitudinal direction relative to the pervious partition, and
a duct that is in fluid communication with the receptacle so that at least some of the fumes can be drawn along a flow path which extends through the pervious partition and then into the duct by way of the receptacle,
wherein:
the receptacle includes a container, which defines an upper opening, and an upwardly open trough for collecting any slag passing through the pervious partition, with the trough being removably mounted to the container so that while the trough is mounted to the container:
the trough at least partially covers the upper opening, and
a chamber is at least partially defined between a portion of the trough and a portion of the container, and
the trough defines an inlet opening through which the flow path enters the chamber, and the container defines an outlet opening through which the flow path exits the chamber.

24. A table that is for supporting a workpiece while the workpiece is being cut in a manner that produces fumes, the table comprising:
a pervious partition having an upper surface for supporting the workpiece while the workpiece is being cut, with the pervious partition having a length extending in a 30 longitudinal direction and a width extending in a lateral direction which is perpendicular to the longitudinal direction; and
a down-draft system for drawing at least some of the fumes downward through the pervious partition, with the down-draft system including:
a receptacle positioned below the pervious partition and mounted for back and forth movement in the longitudinal direction relative to the pervious partition, and
a duct that is in fluid communication with the receptacle so that at least some of the fumes can be drawn along a flow path which extends through the pervious partition and then into the duct by way of the receptacle, and
a passageway by way of which the duct is in the fluid communication with the receptacle, wherein the passageway is mounted to the receptacle so that the passageway extends downwardly from a bottom surface of the receptacle and moves with the receptacle during the back and forth movement of the receptacle.

25. The table according to claim 24, wherein:
the passageway includes a protrusion which extends downwardly from a bottom surface of an outlet end of the passageway that extends into the duct,
the protrusion extends in the longitudinal direction from proximate a first side of the outlet end of the passageway to proximate a second side of the outlet end of the passageway, and
an edge of the protrusion is at least proximate to a seating surface of the duct.

26. A table that is for supporting a workpiece while the workpiece is being cut in a manner that produces fumes, the table comprising:
a pervious partition having an upper surface for supporting the workpiece while the workpiece is being cut, with the pervious partition having a length extending in a longitudinal direction and a width extending in a lateral direction which is perpendicular to the longitudinal direction;
a down-draft system for drawing at least some of the fumes downward through the pervious partition, with the down-draft system including a receptacle positioned below the pervious partition, and a duct that extends in the longitudinal direction, wherein the duct is in fluid communication with the receptacle so that at least some of the fumes can be drawn along a flow path which extends through the pervious partition and then into the duct by way of the receptacle, and the receptacle is mounted for back and forth movement in the longitudinal direction relative to the pervious partition and the duct; and
a frame that carries the pervious partition and is positioned upon a floor,
wherein:
the duct is in fluid communication with the receptacle by way of a mouth that penetrates the duct and is movable back and forth with the receptacle relative to the duct, and
a length of the duct that is penetrated by the mouth is lying on the floor.

27. A table that is for supporting a workpiece while the workpiece is being cut in a manner that produces fumes, the table comprising:
a pervious partition having an upper surface for supporting the workpiece while the workpiece is being cut, with the pervious partition having a length extending in a longitudinal direction and a width extending in a lateral direction which is perpendicular to the longitudinal direction; and
a down-draft system for drawing at least some of the fumes downward through the pervious partition, with the down-draft system including a receptacle positioned below the pervious partition, a duct that extends in the longitudinal direction, and a passageway by way of which the duct is in the fluid communication with the receptacle so that at least some of the fumes can be drawn along a flow path which extends through the pervious partition and then into the duct by way of the receptacle and the passageway, and the receptacle is mounted for back and forth movement in the longitudinal direction relative to the pervious partition and the duct, wherein:
the duct includes:
an elongate inlet opening which extends in the longitudinal direction, and
an elongate flexible flap which extends in the longitudinal direction and is biased toward a closed configuration in which the flap closes the inlet opening,
the passageway is mounted to the receptacle for moving with the receptacle in the longitudinal direction relative to the duct so that an outlet end of the passageway sequentially engages portions of the flap and thereby temporarily moves the portions of the flap from the closed configuration to an open configuration so that portions of the inlet opening are temporarily opened as the passageway moves in the longitudinal direction relative to the duct, so that the flow path enters the duct through the opened portions of the inlet opening,
the passageway includes a protrusion which extends downwardly from a bottom surface of the outlet end of the passageway,
the protrusion extends in the longitudinal direction from proximate a first side of the outlet end of the passageway to proximate a second side of the outlet end of the passageway, and
an edge of the protrusion is at least proximate to a seating surface of the duct.

28. A table that is for supporting a workpiece while the workpiece is being cut in a manner that produces fumes, the table comprising:
a pervious partition having an upper surface for supporting the workpiece while the workpiece is being cut, with the pervious partition having a length extending in a longitudinal direction and a width extending in a lateral direction which is perpendicular to the longitudinal direction; and
a down-draft system for drawing at least some of the fumes downward through the pervious partition, with the down-draft system including a receptacle positioned below the pervious partition, a duct that extends in the longitudinal direction, and a passageway by way of which the duct is in the fluid communication with the receptacle so that at least some of the fumes can be drawn along a flow path which extends through the pervious partition and then into the duct by way of the receptacle and the passageway, and the receptacle is mounted for back and forth movement in the longitudinal direction relative to the pervious partition and the duct, wherein:
the duct includes an elongate inlet opening which extends in the longitudinal direction, and an elongate flexible flap which extends in the longitudinal direction and is biased toward a closed configuration in which the flap closes the inlet opening,
the passageway is mounted to the receptacle for moving with the receptacle in the longitudinal direction relative to the duct so that an outlet end of the passageway sequentially engages portions of the flap and thereby temporarily moves the portions of the flap from the closed configuration to an open configuration so that portions of the inlet opening are temporarily opened as the passageway moves in the longitudinal direction relative to the duct, so that the flow path enters the duct through the opened portions of the inlet opening,
the outlet end of the passageway includes opposite first and second sides that are spaced apart from one another in the longitudinal direction,
the flap extends over the outlet end of the passageway and the first and second sides of the outlet end of the passageway,
the first side of the outlet end of the passageway tapers so as to become narrow at increasing distance from the second side of the outlet end of the passageway,
the first side of the outlet end of the passageway separates a lower portion of the flap from a seating surface of the duct as the receptacle and the passage move in the longitudinal direction toward a first end of the table,
the second side of the outlet end of the passageway tapers so as to become narrow at increasing distance from the first side of the outlet end of the passageway,
the second side of the outlet end of the passageway separates the lower portion of the flap from the seating surface as the receptacle and the passage move in the longitudinal direction toward a second end of the table,
the seating surface and the lower portion of the flap each extend in the longitudinal direction,
the longitudinal and lateral directions extend at least generally in a horizontal plane,
the first side of the outlet end of the passageway includes a first leading edge which separates the lower portion of the flap from the seating surface of the duct as the receptacle and the passageway move in the longitudinal direction toward the first end of the table,

29. The table according to claim 28, the seating surface extends obliquely relative to the horizontal plane.

30. A table that is for supporting a workpiece while the workpiece is being cut in a manner that produces fumes, the table comprising:
a pervious partition having an upper surface for supporting the workpiece while the workpiece is being cut, with the pervious partition having a length extending in a longitudinal direction and a width extending in a lateral direction which is perpendicular to the longitudinal direction; and
a down-draft system for drawing at least some of the fumes downward through the pervious partition, with the down-draft system including a receptacle positioned below the pervious partition, a duct that extends in the longitudinal direction, and a passageway by way of which the duct is in the fluid communication with the receptacle so that at least some of the fumes can be drawn along a flow path which extends through the pervious partition and then into the duct by way of the receptacle and the passageway, and the receptacle is mounted for back and forth movement in the longitudinal direction relative to the pervious partition and the duct, wherein:
the duct includes an elongate inlet opening which extends in the longitudinal direction, and an elongate flexible flap which extends in the longitudinal direction and is biased toward a closed configuration in which the flap closes the inlet opening,
the passageway is mounted to the receptacle for moving with the receptacle in the longitudinal direction relative to the duct so that an outlet end of the passageway sequentially engages portions of the flap and thereby temporarily moves the portions of the flap from the closed configuration to an open configuration so that portions of the inlet opening are temporarily opened as the passageway moves in the longitudinal direction relative to the duct, so that the flow path enters the duct through the opened portions of the inlet opening,
the outlet end of the passageway includes opposite first and second sides that are spaced apart from one another in the longitudinal direction,
the flap extends over the outlet end of the passageway and the first and second sides of the outlet end of the passageway,
the first side of the outlet end of the passageway tapers so as to become narrow at increasing distance from the second side of the outlet end of the passageway,
the first side of the outlet end of the passageway separates a lower portion of the flap from a seating surface of the duct as the receptacle and the passage move in the longitudinal direction toward a first end of the table,
the second side of the outlet end of the passageway tapers so as to become narrow at increasing distance from the first side of the outlet end of the passageway,
the second side of the outlet end of the passageway separates the lower portion of the flap from the seating surface as the receptacle and the passage move in the longitudinal direction toward a second end of the table,
the first side of the outlet end of the passageway tapers as a result of a first portion of a top of the outlet end of the passageway extending toward a bottom of the outlet end of the passageway, and
in a profile view of the first portion of the top of the outlet end of the passageway, the first portion of the top of the outlet end of the passageway defines two curves respectively having centers of curvature which are positioned on opposite sides of the bottom of the outlet end of the passageway.
